(19) United States
(12) Patent Application Publication
(10) Pub. No.: US 2005/0024667 A1
(43) Pub. Date: Feb. 3, 2005

(54) Information management device for image formation apparatus and information management method

(75) Inventors: Osamu Ishibashi, Nagano (JP); Akira Maruyama, Nagano (JP); Kazuhiro Ichikawa, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORORATION

(21) Appl. No.: 10/857,441

(22) Filed: May 28, 2004

(30) Foreign Application Priority Data
May 30, 2003 (JP) 2003-155484

(51) Int. Cl. G06F 15/00

(52) U.S. Cl. 358/1.13; 358/1.9; 358/1.16

(57) ABSTRACT

The information management device of the invention reads diverse pieces of information, for example, a printer ID and the color of toner, from a storage element of each collected toner cartridge (step S100). When the input color of toner is other than black (K), the information management device determines that an operation mode of a color laser printer is a color mode and retrieves an information management database with the input printer ID as a retrieval key (steps S110 and S120). When a retrieved operation mode of the color laser printer is a monochromatic mode, the information management device rewrites the setting of the operation mode in the information management database to the color mode (steps S130 and S140). The information management device provides each user with various services including support mail service, based on the updated information in the information management database.

### BACKGROUND OF THE INVENTION

1. Field of the Invention

The present invention relates to an information management device for an image formation apparatus, as well as to a program used for the information management device and a corresponding information management method.

2. Description of the Prior Art

A customer management system to manage customer information including the names and the postal addresses of respective customers has been proposed as one of information management devices (see, for example, Japanese Patent Laid-Open Gazette No. 10-228507). This system collects specified registration forms with entries of customer information to register and update information.

### SUMMARY OF THE INVENTION

This customer management system requires collection of latest information to update the customer information on a timely basis for effective management. In one example, a laser printer sold as a monochromatic printer may be usable as a color printer by a preset operation (for example, attachment of a color toner cartridge). Such change of the application type of the laser printer is generally carried out by the user and thus does not ensure timely collection of the latest information on the laser printer for information management. This makes the management information rather out of date and prevents sufficient and adequate services from being given to the user.

An information management device for an image formation apparatus of the invention and a corresponding information management method thus aim to adequately update application type information representing an application type of the image formation apparatus. The information management device for the image formation apparatus of the invention and the corresponding information management method also aim to provide each user with adequate services according to the current setting of the application type in the image formation apparatus.

At least part of the above and the other related objects is attained by an information management device for an image formation apparatus of the invention, as well as by a program used for the information management device and a corresponding information management method, as described below.

An information management device of the invention manages information regarding each image formation apparatus, which has a function of switching over an operation mode from a monochromatic mode to a color mode, and the information management device includes: an information storage module that stores information including at least operation mode information representing the operation mode, as information regarding multiple image formation apparatuses; an information acquisition module that acquires identification information used to identify each image formation apparatus and application type information representing an application type of the image formation apparatus; a mode identification module that identifies the operation mode of the image formation apparatus, based on the acquired application type information of the image formation apparatus; an information retrieval module that retrieves an operation mode of the image formation apparatus, which is identified by the identification information acquired by the information acquisition module, from the information storage module with the identification information as a retrieval key; and an information rewriting module that rewrites the operation mode of the image formation apparatus stored in the information storage module to the color mode, in the case where the retrieved operation mode of the image formation apparatus is the monochromatic mode while the operation mode of the image formation apparatus identified by the mode identification module is the color mode.

The information management device of the invention has the information storage module that stores information regarding multiple image formation apparatuses. The information management device acquires the identification information and the application type information of the image formation apparatus and identifies the current setting of the operation mode in the image formation apparatus. The information management device retrieves the operation mode of the image formation apparatus stored in the information storage module with the acquired identification information as a retrieval key. The information management device rewrites the operation mode of the image formation apparatus stored in the information storage module to the color mode, in the case where the retrieved operation mode of the image formation apparatus is the monochromatic mode while the identified current operation mode of the image formation apparatus is the color mode. This arrangement effectively updates the operation mode of the image formation apparatus stored in the information storage module, based on the acquired application type information of the image formation apparatus.

As one aspect of the information management device of the invention, the application type information of the image formation apparatus may include information representing an on-off state of color image formation, and the mode identification module may determine that the operation mode of the image formation apparatus is the color mode when the image formation apparatus has been set in an on-state of color image formation. In this embodiment, the information representing the on-off state of color image formation may be a number of color images formed. Further, in the information management device of the invention, the application type information of the image formation apparatus may be the operation mode of the image formation apparatus. Moreover, in the information management device of the invention, the information acquisition module may acquire the identification information of the image formation apparatus and the application type information of the image formation apparatus from the image formation apparatus via a communication line.

As another aspect of the information management device of the invention, the information acquisition module may acquire the identification information of the image formation apparatus and the application type information of the image formation apparatus from a storage element of a recording material cartridge. In this embodiment, the application type information of the image formation apparatus may include information regarding color of the recording material cartridge, and the mode identification module may determine that the operation mode of the image formation apparatus is the color mode when the color of the recording material cartridge is other than black.

As still another aspect of the information management device of the invention, the information management device may further include a service setting module that sets a specific service, which is given to a user of the image formation apparatus, based on the information stored in the information storage module. In this embodiment, the service setting module may set an expendables information service for the color mode, which is given to the user of the image formation apparatus with setting of the operation mode to the color mode, while setting an expendables information service for the monochromatic mode, which is given to the user of the image formation apparatus with setting of the operation mode to the monochromatic mode.

The technique of the invention is not restricted to the information management device for the image formation apparatus described above, but is also actualized by a program that causes the computer to function as the information management device, a storage medium that stores such a program therein, and a corresponding information management method that manages information regarding the image formation apparatus.

### BRIEF DESCRIPTION OF THE DRAWINGS

FIG. 1 schematically illustrates the configuration of a system including an information management device 20;

FIG. 2 is a block diagram showing the information management device 20;

FIG. 3 shows one example of management information in an information management database 30;

FIG. 4 schematically illustrates the structure of a color laser printer 60;

FIG. 5 shows the state of a developer 61 in each operation mode;

FIG. 6 shows one example of information stored in a storage element;

FIG. 7 is a flowchart showing an information updating process; and

FIG. 8 shows support mails.

### DESCRIPTION OF THE PREFERRED EMBODIMENTS

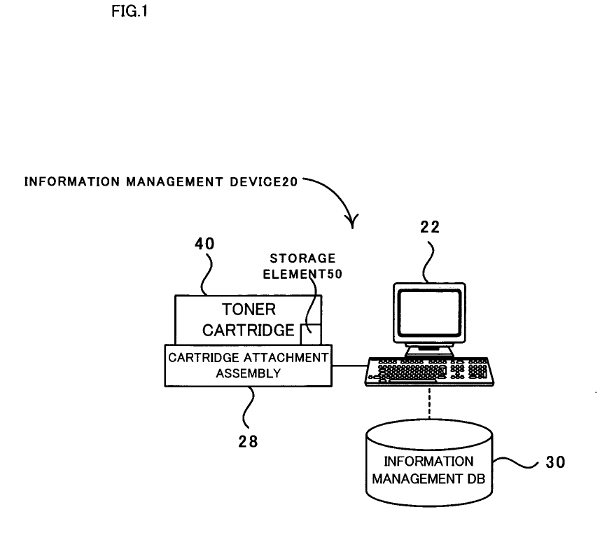

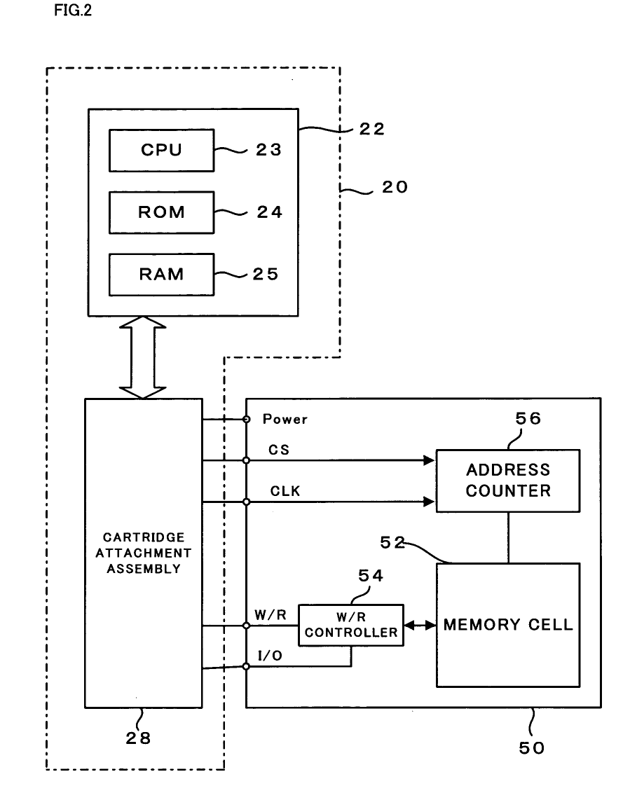

The invention is described specifically with reference to one preferred embodiment. FIG. 1 schematically illustrates the configuration of a system including an information management device 20 that manages information regarding a color laser printer 60 in one embodiment of the invention. FIG. 2 is a block diagram showing electrical connection of functional blocks included in the information management device 20 of the embodiment. As shown in FIGS. 1 and 2, the information management device 20 of the embodiment includes a general-purpose computer 22 having a CPU 23, a ROM 24, a RAM 25, and non-illustrated input/output interfaces, a cartridge attachment assembly 28 that is connected with the computer 22 via the non-illustrated input/output interfaces of the computer 22 and receives each collected toner cartridge 40 attached thereto, and an information management database 30 that is installed in the computer 22. The information management device 20 manages the information regarding the color laser printer 60, based on information read from a storage element 50 of the collected toner cartridge 40 attached to the cartridge attachment assembly 28.

As shown in FIG. 2, the storage element 50 has a memory cell 52 that stores data therein, a read/write controller 54 that controls operations of reading and writing data from and into the memory cell 52, and an address counter 56 that transmits data to and from the information management device 20 of the embodiment and the color laser printer 60 via the read/write controller 54 in response to a clock signal CLK. A typical example of the storage element is an EEPROM

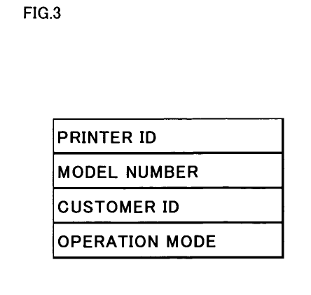

FIG. 3 shows one example of information managed in the information management database 30. As shown in FIG. 3, the information management database 30 is designed to manage diverse pieces of information, for example, an ID allocated to each color laser printer 60 (printer ID), the model number of the color laser printer 60, an ID allocated to a customer as a location of the color laser printer 60 (customer ID), and an operation mode representing selection of either a monochromatic mode and a color mode in the color laser printer 60. These pieces of information are registered at the time of delivery of the color laser printer 60 and are updated in the course of an information update process executed by the information management device 20 of the embodiment. The details of the operation mode of the color laser printer 60 and the information update process will be discussed later.

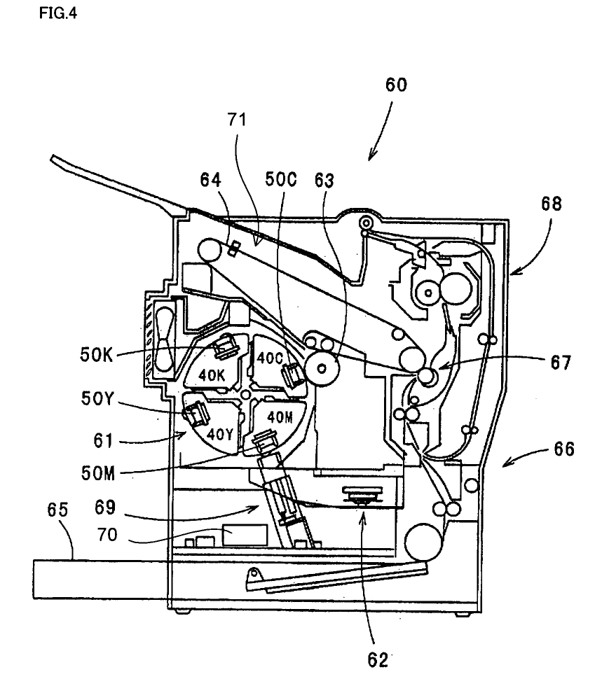

FIG. 4 schematically illustrates the structure of the color laser printer 60. The color laser printer 60 is constructed as a full-color electrophotographic image formation apparatus that adopts a single photoreceptor system and an intermediate transfer system. An original color image is subjected to color separation into four color image components of cyan (C), magenta (M), yellow (Y), and black (K) as illustrated. The system creates electrostatic latent images of the respective color image components on a photoreceptor 63 by means of an exposure unit 62, forms color toner images on the electrostatic latent images with color toners supplied from toner cartridges 40C, 40M, 40Y, and 40K of the respective colors, and transfers the color toner images in an overlapping manner onto a transfer belt 64 as an intermediate transfer member. A secondary transfer unit 67 then functions to transfer the four color toner images, which have been transferred to the transfer belt 64 in the overlapping manner, onto a sheet of printing paper that is supplied from a paper cassette 65 and is fed by means of a feeder unit 66. Resulting color images are completed on the printing paper by fusing and fixing the transferred toner images on the printing paper by means of a fixation unit 68. A developer 61 is designed to be rotatable and form the respective color toner images on the photoreceptor 63. The color laser printer 60 is also provided with a movable connection module 69 that connects with each of storage elements 50C, 50M, 50Y, and 50K of the respective toner cartridges 40C, 40M, 40Y, and 40K attached to the developer 61, when the corresponding storage element is located at a lower right position in the drawing. The controller 70 writes and reads the information on the color laser printer 60 into and from the storage element 50 connected with the movable connection module 69. The electrical connection of the controller 70 with the storage element 50 is similar to the electrical connection of the information management device 20 with the storage element 50 as illustrated in FIG. 2 and is thus not specifically illustrated nor described here.

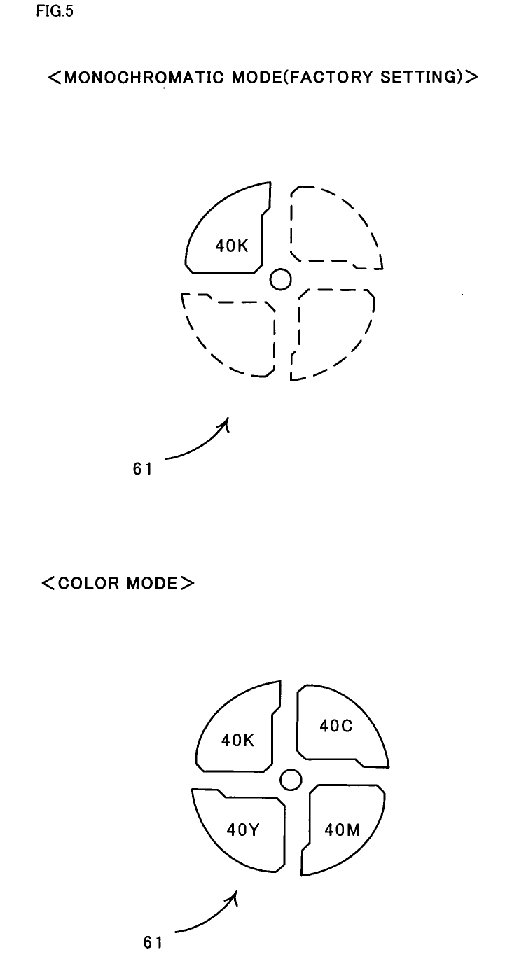

The color laser printer 60 has the monochromatic mode and the color mode as available operation modes as mentioned above, and is set in the monochromatic mode as the factory setting. FIG. 5 shows the state of the developer 61 in the monochromatic mode and the state of the developer 61 in the color mode. As shown in FIG. 5, the color laser printer 60 is set in the monochromatic mode in the case of attachment of only the black toner cartridge 40K for black (K) to the developer 61, while being set in the color mode in the case of additional attachment of the toner cartridges 40C, 40M, and 40Y for cyan (C), magenta (M), and yellow (Y) to the developer 61. In the setting of the monochromatic mode, the color laser printer 60 prints a monochromatic image on printing paper with a supply of the black (K) toner from the toner cartridge 40K and carries out operations characteristic of the monochromatic mode. One example of the operations characteristic of the monochromatic mode displays an error message in response to reception of color print data, which are generated by a printer driver for color printing, from a client computer. The operations in the color mode are identical with those in a conventional color laser printer and are thus not specifically described here.

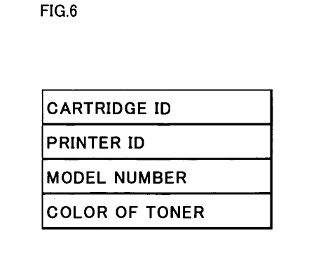

FIG. 6 shows one example of information stored in the storage element 50 of the toner cartridge 40. In the structure of this embodiment, the storage element 50 is designed to store diverse pieces of information, for example, an ID allocated to each toner cartridge 40 (cartridge ID), the printer ID of the color laser printer 60 with the toner cartridge 40 attached thereto, the model number of the color laser printer 60, and the color of toner kept in the toner cartridge 40. Among these pieces of information, the cartridge ID and the color of toner are written into the storage element 50 as the factory settings at the time of manufacturing or recycling the toner cartridge 40. The printer ID and the model number of the color laser printer 60 are written into the storage element 50 by the controller 70 of the color laser printer 60 at the time of attachment or detachment of the toner cartridge 40 to or from the color laser printer 60.

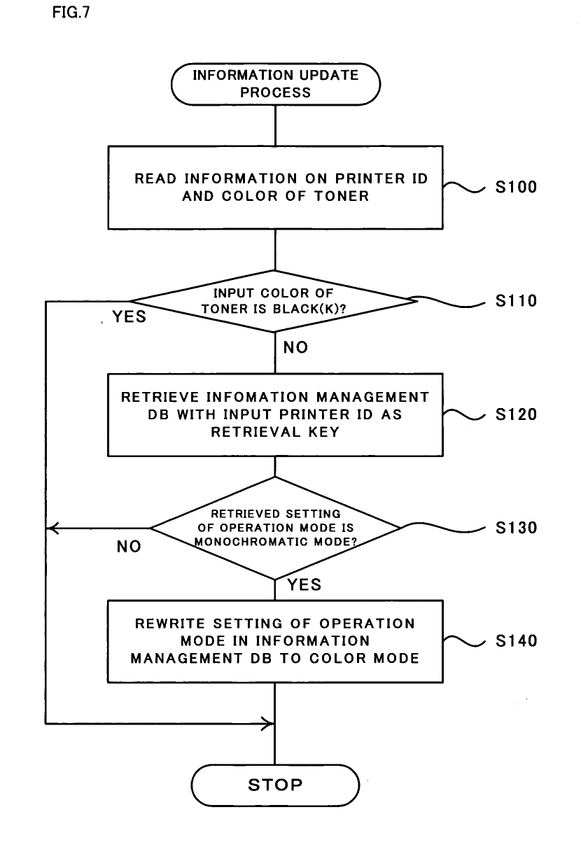

The following describes the operations of the information management device 20 of the embodiment. FIG. 7 is a flowchart showing an information update process, which is executed by the information management device 20 of the embodiment, in response to attachment of each collected toner cartridge 40 to the cartridge attachment assembly 28. The information update process first reads the respective pieces of information, for example, the printer ID and the color of toner, from the storage element 50 of the toner cartridge 40 attached to the cartridge attachment assembly 28 (step S100). The information is read in response to a read signal, which is output from the computer 22 to the read/write controller 54 of the storage element 50 in the toner cartridge 40 attached to the cartridge attachment assembly 28.

The information update process determines whether the input color of toner is black (K) (step S110). When the input color of toner is black (K), the information update process skips all the subsequent steps and is terminated immediately. When the input color of toner is other than black (K) (that is, any of cyan (C), magenta (M), and yellow (Y)), the information update process determines that the color laser printer 60 with the toner cartridge 40 attached thereto has been used in the color mode and retrieves the information management database 30 with the printer ID input at step S100 as a retrieval key (step S120).

When the retrieved setting of the operation mode of the color laser printer 60 from the information management database 30 is the ‘color mode’, the information update process skips all the subsequent steps and is terminated immediately. When the retrieved setting of the operation mode is the ‘monochromatic mode’, on the other hand, the information update process rewrites the setting of the operation mode in the information management database 30 to the ‘color mode’ (steps S130 and S140), before being terminated.

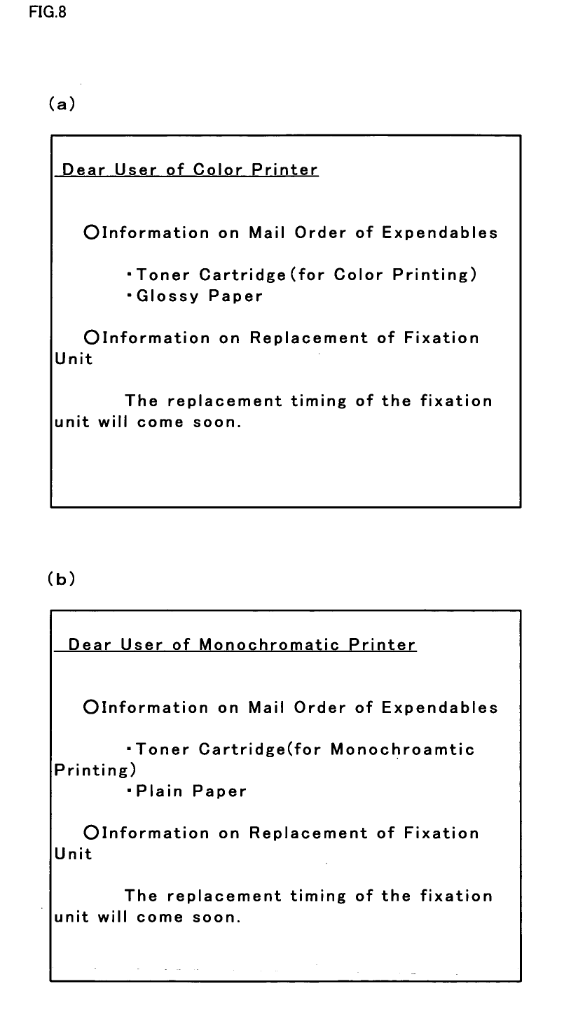

The information management device 20 provides the user of the color laser printer 60 with various services, based on the information stored in the information management database 30 updated by the information update process. FIG. 8 shows support mails, which are output by the information management device 20 and are sent to the user by e-mail or by post. This example gives mail notice including information on mail order of expendables (for example, toner cartridge and paper) and on a replacement timing of a replacement part (for example, the fixation unit 68). The support mail shown in FIG. 8(a) is sent to the user of the color printer (that is, in the case of the setting of the ‘color mode’ to the operation mode registered in the information management database 30), to give notice of information on expendables for the color printer and on a replacement timing of the replacement part expected on the criterion for the color printer. The support mail shown in FIG. 8(b) is sent to the user of the monochromatic printer (that is, in the case of the setting of the ‘monochromatic mode’ to the operation mode registered in the information management database 30), to give notice of information on expendables for the monochromatic printer and on a replacement timing of the replacement part expected on the criterion for the monochromatic printer. The criterion of the replacement timing of the replacement part depends upon the setting of the operation mode. This is because the different operation modes may lead to the different deterioration rates of the replacement part (for example, the fixation temperature in the color mode tends to be higher than the fixation temperature in the monochromatic mode, so that the deterioration rate of the fixation unit 68 in the color mode is apt to be higher than that in the monochromatic mode).

As described above, the information management device 20 of the embodiment acquires the information on the color of toner from the storage element 50 of each collected toner cartridge 40 and, when the acquired information on the color of toner is other than black (K), determines that the color laser printer 60 with the collected toner cartridge 40 attached thereto has been used in the color mode and rewrites the setting of the operation mode to the ‘color mode’ in the information management database 30. The setting of the operation mode of the color laser printer 60 registered in the information management database 30 is thus updatable to the latest condition by simple attachment of the collected toner cartridge 40 to the cartridge attachment assembly 28. The information management device 20 provides the user with various services, for example, support mail service, based on the updated information registered in the information management database 30. The arrangement of the embodiment thus enables the user to receive adequate services according to the setting of the operation mode in the color laser printer 60.

The information management database 30 included in the information management device 20 of the embodiment corresponds to the information storage module of the invention. The cartridge attachment assembly 28 and the computer 22 that executes the processing of step S100 in the embodiment correspond to the information acquisition module of the invention. The computer 22 executing the processing of step S110 corresponds to the mode identification module, the computer 22 executing the processing of step S120 corresponds to the information retrieval module, and the computer 22 executing the processing of steps S130 and 140 corresponds to the information rewriting module.

The information management device 20 of the embodiment determines that the operation mode of the color laser printer 60 is the color mode, when the information on the color of toner acquired from the storage element 50 of the toner cartridge 40 is other than black (K). The operation mode of the color laser printer 60 may alternatively be identified, based on any suitable piece of information other than the color of toner. One modified procedure stores the number of color prints in the storage element 50 and determines that the operation mode of the color laser printer 60 is the color mode when the stored number of color prints is not less than 1. Another modified procedure stores a color print flag representing the on-off state of color printing in the storage element 50 and determines that the operation mode of the color laser printer 60 is the color mode when the setting of the color print flag represents the on state of color printing (for example, when the setting of the color print flag is equal to 1). Still another modified procedure stores the setting of the operation mode itself in the storage element 50 and identifies the operation mode based on the stored setting of the operation mode. Another modified procedure sets different values to the model number of the color laser printer 60 in the respective operation modes (for example, ‘xxx-c’ for the color mode and ‘xxx-b’ for the monochromatic mode) and identifies the operation mode based on the setting of the model number.

The information management device 20 of the embodiment obtains the information on the printer ID and the color of toner from the storage element 50 of each collected toner cartridge 40 attached to the cartridge attachment assembly 28. In the case where the color laser printer 60 is connected to the information management device 20 via a communication line like the Internet, the information on the printer ID and the color of toner may be obtained from the color laser printer 60 via the communication line. In this modified structure, the information on the printer ID and the color of toner may not be stored into the storage element 50 of the toner cartridge 40, but may be stored in a non-illustrated ROM or RAM of the color laser printer 60 and obtained from the ROM or RAM via the communication line.

The information management device 20 of the embodiment provides the user with the support mail service, based on the information stored in the information management database 30. The information management device 20 may also provide the user with diversity of other services.

The information management device 20 of the embodiment manages the information on the color laser printer 60, which is constructed as a full-color electrophotographic image formation apparatus of the single photoreceptor system and the intermediate transfer system. The technique of the invention is applicable to manage information on any image formation apparatus having the function of switching over the operation mode from the monochromatic mode to the color mode. The technique of the invention may thus be adopted to manage information on any of color laser printers and color photocopiers that are constructed as full-color electrophotographic image formation apparatuses of the multiple photoreceptor system and the direct transfer system, as well as on any of color inkjet printers.

The above embodiment regards the information management device 20 that manages the information on the color laser printer 60. The technique of the invention may also be actualized by a corresponding information management method or a computer program that causes a single or multiple computers to function as the information management device 20. In the latter structure, the respective steps of the information update process shown in the flowchart of FIG. 7 maybe programmed in an adequate program language and installed in the computer.

The above preferred embodiments are to be considered in all aspects as illustrative and not restrictive. There may be many modifications, changes, and alterations without departing from the scope or sprit of the main characteristics of the present invention. All changes within the meaning and range of equivalency of the claims are therefore intended to be embraced therein.

1. An information management device that manages information regarding each image formation apparatus, which has a function of switching over an operation mode from a monochromatic mode to a color mode, said information management device comprising:
an information storage module that stores information including at least operation mode information representing the operation mode, as information regarding multiple image formation apparatuses;
an information acquisition module that acquires identification information used to identify each image formation apparatus and application type information representing an application type of the image formation apparatus;
a mode identification module that identifies the operation mode of the image formation apparatus, based on the acquired application type information of the image formation apparatus;
an information retrieval module that retrieves an operation mode of the image formation apparatus, which is identified by the identification information acquired by said information acquisition module, from said information storage module with the identification information as a retrieval key; and
an information rewriting module that rewrites the operation mode of the image formation apparatus stored in said information storage module to the color mode, in the case where the retrieved operation mode of the image formation apparatus is the monochromatic mode while the operation mode of the image formation apparatus identified by said mode identification module is the color mode.

2. An information management device in accordance with claim 1, wherein the application type information of the image formation apparatus comprises information representing an on-off state of color image formation, and
said mode identification module determines that the operation mode of the image formation apparatus is the color mode when the image formation apparatus has been set in an on-state of color image formation.

3. An information management device in accordance with claim 2, wherein the information representing the on-off state of color image formation is a number of color images formed.

4. An information management device in accordance with claim 1, wherein the application type information of the image formation apparatus is the operation mode of the image formation apparatus.

5. An information management device in accordance with claim 1, wherein said information acquisition module acquires the identification information of the image formation apparatus and the application type information of the image formation apparatus from the image formation apparatus via a communication line.

6. An information management device in accordance with claim 1, wherein said information acquisition module acquires the identification information of the image formation apparatus and the application type information of the image formation apparatus from a storage element of a recording material cartridge.

7. An information management device in accordance with claim 6, wherein the application type information of the image formation apparatus comprises information regarding color of the recording material cartridge, and
said mode identification module determines that the operation mode of the image formation apparatus is the color mode when the color of the recording material cartridge is other than black.

8. An information management device in accordance with claim 1, said information management device further comprising:
a service setting module that sets a specific service, which is given to a user of the image formation apparatus, based on the information stored in said information storage module.

9. An information management device in accordance with claim 8, wherein said service setting module sets an expendables information service for the color mode, which is given to the user of the image formation apparatus with setting of the operation mode to the color mode, while setting an expendables information service for the monochromatic mode, which is given to the user of the image formation apparatus with setting of the operation mode to the monochromatic mode.

10. A storage medium that stores a program used for an information management device, said information management device managing information regarding each image formation apparatus, which has a function of switching over an operation mode from a monochromatic mode to a color mode, said program comprising:
a module (a) that stores information including at least operation mode information representing the operation mode, as information regarding multiple image formation apparatuses;
a module (b) that acquires identification information used to identify each image formation apparatus and application type information representing an application type of the image formation apparatus;
a module (c) that identifies an operation mode of the image formation apparatus, based on the acquired application type information of the image formation apparatus;
a module (d) that retrieves an operation mode of the image formation apparatus, which is identified by the identification information acquired by said module (b), from the information stored by said module (a) with the identification information as a retrieval key; and
a module (e) that rewrites the operation mode of the image formation apparatus stored by said module (a) to the color mode, in the case where the retrieved operation mode of the image formation apparatus is the monochromatic mode while the operation mode of the image formation apparatus identified by said module (c) is the color mode.

11. An information management method managing information regarding each image formation apparatus, which has a function of switching over an operation mode from a monochromatic mode to a color mode, said information management method comprising the steps of:
(a) storing information including at least operation mode information representing the operation mode, as information regarding multiple image formation apparatuses;
(b) acquiring identification information used to identify each image formation apparatus and application type information representing an application type of the image formation apparatus;
(c) identifying an operation mode of the image formation apparatus, based on the acquired application type information of the image formation apparatus;
(d) retrieving an operation mode of the image formation apparatus, which is identified by the identification information acquired in said step (b), from the information stored in said step (a) with the identification information as a retrieval key; and
(e) rewriting the operation mode of the image formation apparatus stored in said step (a) to the color mode, in the case where the retrieved operation mode of the image formation apparatus is the monochromatic mode while the operation mode of the image formation apparatus identified in said step (c) is the color mode.
